(19) United States
(12) Patent Application Publication
(10) Pub. No.: US 2001/0052885 A1
(43) Pub. Date: Dec. 20, 2001

(54) Method for driving a nematic liquid crystal

(76) Inventor: Masaya Okita, Yono-shi (JP)

Correspondence Address: FLYNN, THIEL, BOUTELL & TANIS, P.C., 2026 Rambling Road, Kalamazoo, MI, 49008-1699, US

(21) Appl. No.: 09/801,098

(22) Filed: Mar. 7, 2001

Related U.S. Application Data
(63) Continuation-in-part of application No. 09/115,018, filed on Jul. 14, 1998, now abandoned.

(30) Foreign Application Priority Data
Sep. 12, 1997 (JP) 9-267819

(51) Int. Cl. G09G 3/36

(52) U.S. Cl. 345/87

(57) ABSTRACT

In a liquid crystal display device including a nematic liquid crystal confined between two electrodes with polarizing plates, a voltage applied between two electrodes to drive the nematic liquid crystal is maintained at a predetermined value for a predetermined duration of time in predetermined intervals to increase the response speed and to realize color images by tricolor back-lighting or moving images equivalent to or better than those provided by CRT displays.

This application is a continuation-in-part from Application Ser. No. 09/115 018, filed Jul. 14, 1998.

### BACKGROUND OF THE INVENTION

1. Field of the Invention

This invention relates to a method for driving a liquid crystal, especially, a nematic liquid crystal.

2. Description of the Related Art

When two transparent flat plates having transparent electrodes and sandwiching a nematic liquid crystal are placed between two polarizing plates, transmittance of light passing through the polarizing plates changes with the voltage applied across the transparent electrodes.

Since liquid crystal display devices based on the above principle can be shaped flat and are operative with low electric power, they have been widely used in wrist watches, electronic calculating machines, and so forth. In recent years, they are also used in combination with color filters to form color display devices in note-type personal computers and small liquid crystal TV sets, for example.

A problem with conventional liquid crystal display devices is slow responses of liquid crystals. In this respect, liquid crystal display devices have been inferior to CRT displays especially when used as TV displays for displaying moving images or as personal computer displays required to quickly follow the movements of a mouse cursor.

In liquid crystal displays combined with color filters to display color images, three dots of different colors, namely, red, green and blue, are combined to display a desired color. A problem with the use of color filters lies in that color filters are very expensive and need a high accuracy when bonded to panels. Moreover, they need a triple number of dots to ensure an equivalent resolution as compared with black-and-white liquid crystal display panels. Therefore, typical liquid crystal color panels require a triple number of drive circuits in the horizontal direction. This means an increase of the cost of drive circuits themselves and the cost for an increased man-hour for connecting drive circuits to the panel at a triple number of points.

Another problem with the use of color filters is their optical transmittance as low as approximately 20%. When color filters are used in a liquid crystal panel, the brightness decreases to approximately one fifth, and a large electric power is consumed for back-lighting to compensate the lack of brightness.

Thus, the use of color filters with liquid crystal panels to display color images involved many disadvantageous factors from the economical viewpoint, and its was difficult to manufacture an economical liquid crystal panel for color images using this method.

Japanese Patent Laid-Open 1-179914 (1989) discloses a color liquid crystal display device to display color images by combining a black-and-white panel and tricolor back-lighting instead of using color filters. This method certainly appears more likely to realize high-fidelity color images inexpensively. Practically, however, response speeds of nematic liquid crystals by conventional liquid crystal driving methods are as slow as several decades of milliseconds through hundreds of milliseconds, and it has been believed difficult to realize a response speed not slower than 8 milliseconds required for color images by tricolor back-lighting with a liquid crystal panel using a nematic liquid crystal.

There are also some proposals to use ferroelectric liquid crystals or antiferroelectric liquid crystals to provide liquid crystal panels operative at a high speed. However, no such device has been brought into practice mainly because the cell gaps of the liquid crystal must be as small as 1 μm and are difficult to make.

### SUMMARY OF THE INVENTION

It is therefore an object of the invention to provide a nematic liquid crystal driving method which increases the response speed of any conventional nematic liquid crystal, either of the twisted nematic (TN) type or of the supertwisted nematic (STN) type, to enable coloring by tricolor back-lighting and to ensure the performance equivalent to or higher than CRT displays in reproduction of moving images.

The Inventor measured dynamic characteristics of applied voltage waveforms and optical transmittance of nematic liquid crystals to develop a liquid crystal panel having a response speed enabling color images by tricolor back-lighting, and has confirmed that, depending on the waveform of the applied voltage, there occurs the phenomenon that the optical transmittance changes very quickly in response to changes in applied voltage. If this phenomenon is repetitively produced, it must be possible to increase the response speed of the liquid crystal. The present invention is based on the above knowledge of the Inventor, and its basic concept lies in increasing the response speed of a liquid crystal by applying a voltage to the liquid crystal at a unique timing different from those of conventional driving circuits.

That is, according to the invention, there is provided a method for driving a nematic liquid crystal in a liquid crystal display device which includes a nematic liquid crystal, two electrodes confining the nematic liquid crystal and a pair of polarizing plates sandwiching the electrodes confining the nematic liquid crystal, comprising:

the voltage applied across two electrodes being returned to and maintained in a predetermined value for a predetermined duration of time in predetermined intervals.

In the duration of time other than the predetermined duration of time in each interval, the voltage applied across two electrodes may be inverted in polarity.

The nematic liquid crystal may be heated to a predetermined temperature.

According to the invention, by returning or maintaining the voltage across two electrodes to or in a predetermined value for a predetermined time in predetermined intervals, the liquid can be driven at a much higher response speed than those of conventional driving methods. Therefore, a liquid crystal panel suitable for color images by tri-color back-lighting and for moving images with a high contrast ratio can be realized. It is also possible to reduce the power consumption.

### BRIEF DESCRIPTION OF THE DRAWINGS

FIG. 1 is a diagram showing the waveform of voltages applied to a nematic liquid crystal by a nematic liquid crystal driving method according to an embodiment of the invention, together with absolute values of the voltages and responsive changes with time in optical transmittance of the nematic liquid crystal; and

FIG. 2 is a diagram showing the waveform of voltages applied to a nematic liquid crystal by a conventional driving method, together with absolute values of the voltages and responsive to changes with time in optical transmittance of the nematic liquid crystal.

FIG. 3 is a characteristic diagram of a liquid crystal having no substantial memory property.

### DESCRIPTION OF THE PREFERRED EMBODIMENT

Explained below is an embodiment of the invention with reference to the drawings.

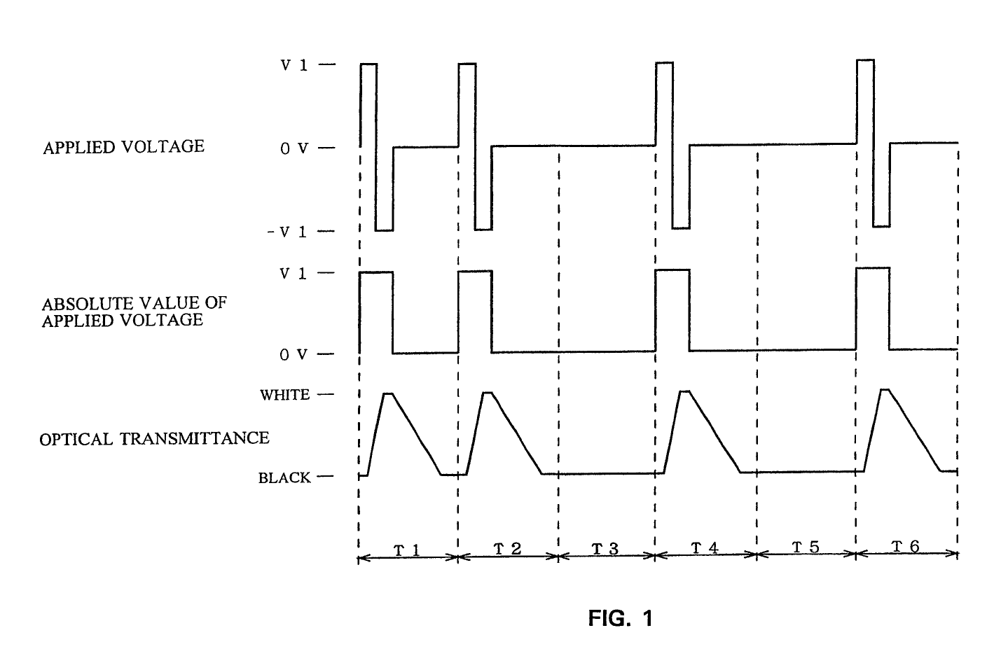

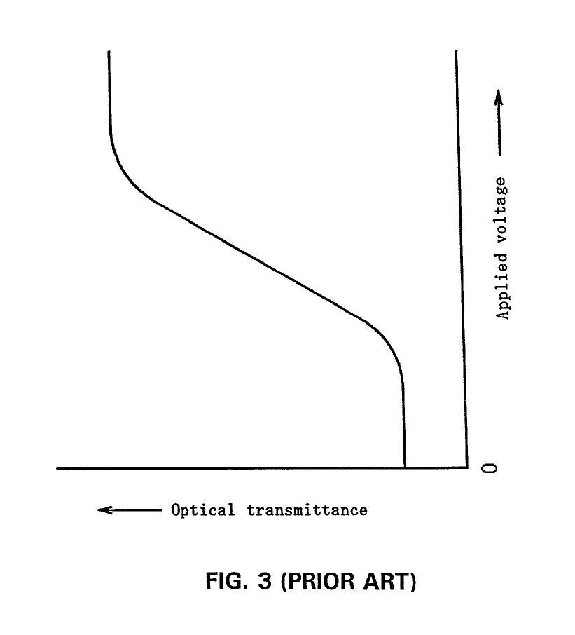

FIG. 1 shows an aspect where a voltage is applied to a high-speed nematic liquid crystal panel using an appropriate one of conventional TN liquid crystals or STN liquid crystals and optimizing the cell gap. Further, intervals, T1 through T6, are equal in length, and the length is not longer than 8 milliseconds which is the slowest acceptable driving cycle required for driving a liquid crystal for color images by tricolor back-lighting. Consequently, the embodiment is intended to use a liquid crystal having electro-optic characteristics substantially as shown in FIG. 3, namely, having no substantial memory property.

As already known, optical transmittance of a liquid crystal changes with absolute values of applied voltages regardless of their polarities. However, the applied voltage is usually changed in polarity in predetermined intervals because continuous application of a d.c. voltage to a liquid crystal will cause an electrochemical reaction and will deteriorate the liquid crystal. Therefore, also in the embodiment of the invention, applied voltages are inverted in polarity. However, inversion of polarities is substantially immaterial to the subject matter of the invention, namely, high-speed driving of a liquid crystal. Now explained below is the operation of the embodiment of the invention with reference to the drawings.

In FIG. 1 showing the driving method according to the embodiment of the invention, each of the intervals of time T1 through T6 includes two time zones. One of these time zones (the former of each of T1 through T6 in FIG. 1) is the time where a voltage responsive to image data is applied, and the absolute value represents V1 or 0 V depending upon the image data. The other time zone (the latter of each of T1 through T6) is the time where the voltage of 0 V is applied irrespectively of the image data. That is, in the present embodiment, the applied voltage is forcibly changed to or maintained in 0 V for a predetermined time in predetermined intervals.

More specifically, in the interval T3 and the interval T5 in FIG. 1, also the applied voltage responsive to image data is 0 V, and the optical transmittance maintains the black level throughout the intervals. In each of the intervals T1, T2, T4 and T6, the applied voltage first becomes V1 in response to image data, and is forcibly changed to 0 V later. Responsively, the optical transmittance first changes from the black level to the white level and then changes from the white level to the black level. That is, the optical transmittance changes from the black level to the white level, and returns from the black level to the white level within each interval, T1, T2, T4 or T6.

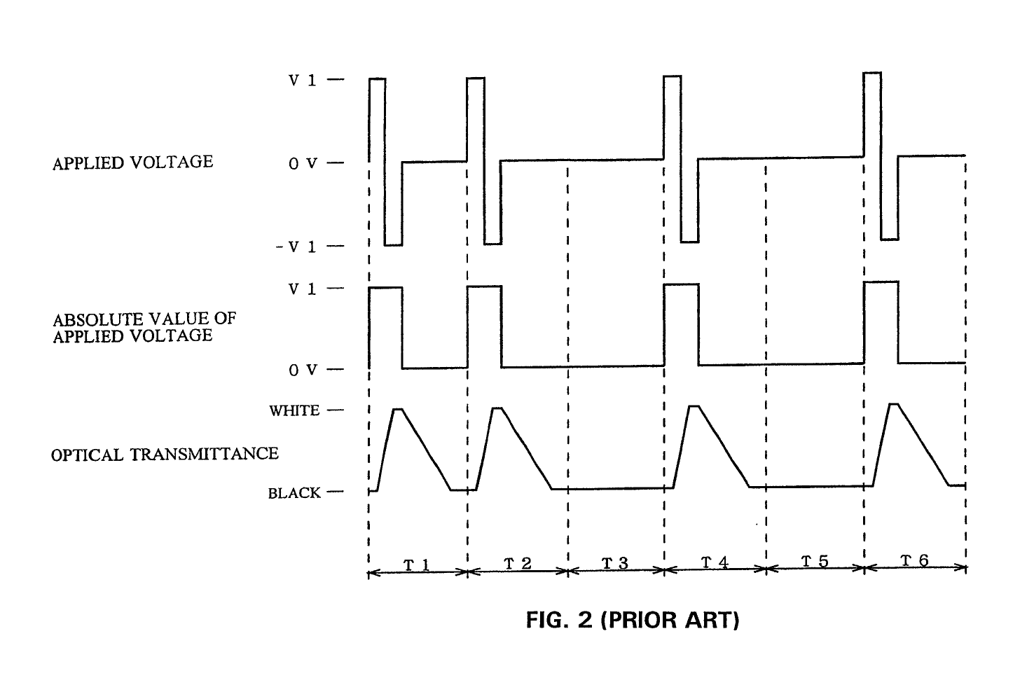

For a better understanding of the embodiment of the invention, a conventional driving method is explained below with reference to FIG. 2. FIG. 2 shows an aspect where a voltage is applied by using the same nematic liquid crystal panel as used in FIG. 1, and the same image data is supplied. Also the intervals T1 through T6 are the same as those of FIG. 1.

As shown in FIG. 2, in the conventional driving method, the applied voltage is determined exclusively by image data. Therefore, the absolute value of the applied voltage becomes V2 or 0 V, depending upon the image data to be displayed, but the value is maintained throughout the interval, or beyond the interval, until an image data is changed to the next image data. In this case, the movement of the liquid crystal is slow, and it takes time for the optical transmittance to change. For example, even when the absolute of the applied voltage changes from V2 to 0 V, like T2 to T3 in FIG. 2, the optical transmittance does not change to the full black level within the interval T3. Further, when the absolute value of the applied voltage changes from 0 V to V2 like T3 to T4 in FIG. 2, the optical transmittance begins to change from an incomplete black level toward the full black level, but fails to return to the full white level within the interval T4. That is, the response speed of the liquid by the conventional driving method is slow, and high-contrast images cannot be displayed at a sufficient speed either on a TN liquid crystal panel or on a STN liquid crystal panel.

It will be understood form comparison of FIG. 1 and FIG. 2 that the embodiment can change the optical transmittance from the black level to the white level or vice versa more quickly by changing the applied voltage to 0 V for a predetermined time in predetermined intervals. Additionally, the embodiment can use a higher applied voltage V1 than V2 of the conventional method to change the optical transmittance to the white level. This is effective for more quickly changing the optical transmittance from the black level to the white level.

Consequently, the embodiment of the invention inverts the polarity within each interval (T1 through T6) so that the average voltage becomes substantially 0 V in each interval (T1 to T6). Since the liquid crystal moves very quickly, if the polarity is inverted between two adjacent intervals (for example, if the polarity in the interval T1 is positive, the polarity is changed to negative in the interval T1), flickers will occur due to a delicate difference between absolute values of the positive applied voltage and the negative applied voltage.

In order to ensure high-contrast images in the embodiment of the invention, it is important to change and return the optical transmittance of the liquid crystal panel within each interval. Therefore, the frame cycle must be set appropriately in accordance with characteristics of the liquid crystal. If the frame period is short, the optical transmittance of a certain liquid crystal fails to return to the original level within the interval, and it results in a decrease in contrast ratio. In contrast, if the frame period is long, flickers are liable to occur.

The duration of time required for the optical transmittance to return to the original level largely varies with the property of the liquid crystal material, especially, the viscosity of the liquid crystal material. Therefore, by selecting an appropriate liquid crystal whose optical transmittance quickly returns to the original level, high-contrast images with substantially no flicker can be realized. Even when a normal liquid crystal is used, the time for returning the optical transmittance to the original level can be shortened by increasing the temperature to adjust the viscosity, and high-contrast images can be ensured.

Although the embodiment has been explained by way of a specific embodiment, it is not limited to these examples, but involves various changes or modifications.

For example, the embodiment shown in FIG. 1 has been explained as using a normally-black liquid crystal panel which displays black under no applied voltage. However, the same effects are promised even with a normally-white liquid crystal panel configured to display white under no applied voltage, by appropriately modifying the voltage to be applied for a predetermined time in predetermined intervals. Also with special liquid panels different from typical liquid crystal panels in relation between the applied voltage and the optical transmittance, substantially the same effects are promised by appropriately modifying the voltage to be applied for a predetermined time in predetermined intervals.

As described above, according to the invention, since the applied voltage to the liquid crystal is returned to a predetermined voltage value for a predetermined time in predetermined intervals, the liquid can be driven very quickly. Therefore, on a liquid crystal panel using the invention, the operation for displaying and completely erasing an image can be completed in a very short time, and high-quality moving images are promised.

Additionally, since the waveform of the applied voltage used in the invention is essentially the same as that used for thin-film-transistor (TFT) systems, the invention is applicable also to TFT liquid crystal panels. Also for other driving systems, the operation speed of liquid crystals can be increased by appropriately changing the applied voltage value for a predetermined time in predetermined intervals.

Moreover, since the method according to the invention is configured to complete the operation for displaying an image and erasing it completely within each frame interval, it is optimum for color images by tricolor back-lighting, and can realize high-performance, inexpensive color displays.

What is claimed is:

1. A method for driving a nematic liquid crystal in a liquid crystal display device which includes a nematic liquid crystal, two electrodes confining said nematic liquid crystal and a pair of polarizing plates sandwiching said electrodes confining the nematic liquid crystal, comprising:
applying a first voltage responsive to image data across said two electrodes during a first predetermined time period in a driving cycle, the driving cycle comprising one of a plurality of driving cycles, each cycle including a separate input of image data; and
applying a second voltage of a constant value independent from the image data across said two electrodes for a second predetermined time period in each of the cycles, the sum of the first and second time periods equaling the entirety of a total time period for each of the driving cycles, whereby response time for transmittance of said liquid crystal display device is enhanced.

2. The method for driving a nematic liquid crystal according to claim 1 wherein the first voltage applied between said two electrodes is inverted in polarity within each said each cycle so as to make the average of voltage values to substantially zero volts within said each cycle.

3. The method for driving a nematic liquid crystal according to claim 1 wherein said nematic liquid crystal is heated to a predetermined temperature.

4. The method for driving a nematic liquid crystal according to claim 2 wherein said nematic liquid crystal is heated to a predetermined temperature.

5. The method for driving a nematic liquid crystal according to claim 1, wherein the constant value of the second voltage maintained across the two electrodes having the constant value for the second predetermined time period for each said driving cycle is zero volts.

6. The method for driving a nematic liquid crystal according to claim 1, wherein the first voltage applied across the two electrodes is inverted in polarity during the first predetermined time period of each said driving cycle and the average of the first and second voltages is substantially zero for each of the driving cycles.

7. The method for driving a nematic liquid crystal according to claim 6, wherein the constant value of the second voltage applied across the two electrodes for the second predetermined time period is zero volts for each of the driving cycles.

8. The method for driving a nematic liquid crystal according to claim 1, wherein the nematic liquid crystal comprises a twisted nematic liquid crystal.

9. The method for driving a nematic liquid crystal according to claim 1, wherein the nematic liquid crystal comprises a supertwisted nematic liquid crystal.

10. The method for driving a nematic liquid crystal according to claim 1, wherein the nematic liquid crystal display device comprises a TFT nematic liquid crystal display device.

11. A method for driving a nematic liquid crystal in a liquid crystal display device that includes a nematic liquid crystal, two electrodes confining the nematic liquid crystal and a pair of polarizing plates sandwiching the electrodes confining the nematic liquid crystal, comprising:
applying a first voltage responsive to image data across said two electrodes during a first predetermined time zone in an interval, the interval comprising one of a plurality of intervals, each interval including a separate input of the image data and a predetermined time period; and
applying a second voltage having a constant value of zero volts during a second predetermined time zone in each of the intervals, the first and second time zones, in combination, equaling the predetermined time period for each of the intervals;
wherein the optical transmittance returns to or remains at an original level during each of the intervals.

12. The method for driving a nematic liquid crystal according to claim 11, wherein each of the intervals is less than or equal to 8 milliseconds.

13. The method for driving a nematic liquid crystal according to claim 11, wherein the nematic liquid crystal comprises a twisted nematic liquid crystal.

14. The method for driving a nematic liquid crystal according to claim 11, wherein the nematic liquid crystal comprises a supertwisted nematic liquid crystal.

15. The method for driving a nematic liquid crystal according to claim 11, wherein the first voltage applied across the two electrodes during the first time zone is inverted in polarity so that the average of the first and second voltages is substantially zero for each of the intervals.

16. The method for driving a nematic liquid crystal according to claim 11, wherein the nematic liquid crystal is heated to a predetermined temperature.

17. The method for driving a nematic liquid crystal according to claim 12, wherein the nematic liquid crystal is heated to a predetermined temperature.

18. The method for driving a nematic liquid crystal according to claim 15, wherein the original level of optical transmittance is black.

19. The method for driving a nematic liquid crystal according to claim 11, wherein the second time zone has a greater duration than the first time zone.

20. The method for driving a nematic liquid crystal according to claim 11, wherein the nematic liquid crystal display device comprises an active matrix liquid crystal display device.

21. The method for driving a nematic liquid crystal according to claim 11, wherein the nematic liquid crystal has substantially no memory property.
